(19) United States
(12) Patent Application Publication
(10) Pub. No.: US 2005/0236488 A1
(43) Pub. Date: Oct. 27, 2005

(54) Motion induced blur minimization in a portable image reader

(76) Inventor: Gregg R. Kricorissian, Ottawa (CA)

Correspondence Address: PEARNE & GORDON LLP, 1801 EAST 9TH STREET, SUITE 1200, CLEVELAND, OH, 44114-3108, US

(21) Appl. No.: 10/831,861

(22) Filed: Apr. 26, 2004

(51) Int. Cl. G06K 7/10

(52) U.S. Cl. 235/472.01

(57) ABSTRACT

The invention describes a method and apparatus for reducing motion-induced blur inherent in portable image readers. The method consists of adding a time delay to the operation of the reader after the trigger has been activated, in order to delay the start of the acquisition cycle. When the trigger or button on a portable imaging reader is pulled or pressed, the motion imparted on the reader can be excessive. Images acquired during this time generally suffer from excessive blurring. Incorporating a short delay between trigger and acquisition, allows the image acquisition to occur at an optimal time when the reader motion is at a minimum. The time delay may be of a fixed duration in the range of 50 ms to 250 ms. In another arrangement, the time delay may determined by the time it takes for the reader motion to decelerate below a predetermined threshold.

### FIELD OF INVENTION

The present invention relates to portable image readers for collecting optical image data and more particularly to a method for reducing motion-induced blur inherent in portable image readers.

### BACKGROUND OF THE INVENTION

Optical readers have been developed to read a symbology that is typically marked on the surface of an article. The symbology contains encoded data represented as light and dark regions arranged in a one-dimensional pattern or with a greater data density, in a two-dimensional pattern.

An operator aligns the image reader with the target symbology and the reader optically senses the light reflected from different parts of the target using a photosensitive detector. The light intensity information is processed to determine the encoded data. In laser scanning devices, a laser beam is scanned over the target and a photosensitive detector records the intensity information of the reflected laser beam and decodes the encoded data of the symbology based on the variations in intensity of the reflections. To cover the whole target of a two-dimensional symbology, the laser is scanned in a raster pattern. Because the hand motion of a human operator is inherently unsteady, the reflected beam may suffer temporal displacement in relation to the output laser beam. This displacement causes blurring of the detected light intensity.

Other types of optical readers include bar code and image readers, which capture an image of a target. In these devices, the target is illuminated and a photosensitive detector captures an image of the target then processes the image to determine the encoded data of the symbology. In comparison to laser scanners, these devices are typically faster, more versatile and can be used for the dual purpose of capturing an image of any target such as a graphic, an illustration, a picture or a symbology, and of simultaneously decoding a symbology if contained within the image.

In portable image readers, a trigger or switch of some kind is used to activate the start of the integration cycle. The photosensitive detector array is made up of picture elements (pixels) arranged in rows and columns. During the integration cycle these pixels are exposed to the illuminated target for a period of time and an image of the target is acquired. Because the hand motion of a human operator is inherently unsteady, motion induced blurring of the acquired image often occurs due to the inadvertent muscular reaction as the trigger is pulled. It could also result from a reaction to any mechanical stimulus during the trigger process. Further, if the target is not static, such as in the case of a package moving on a conveyor belt, then this induced blur is even more problematic.

A common practice used in the art, is to reduce the blur by introducing shorter integration times. This means that the photosensitive array is exposed to the illuminated image for a shorter period of time. This reduces the motion induced blur, however, it also causes reduced contrast and the need for increased illumination levels.

Other techniques for reducing motion induced blur describe techniques to detect the amount of motion in the camera and compensate for this motion. U.S. Pat. No. 5,708,863, which issued to Satoh et al on Jan. 13, 1998, describes such a technique that uses shake determining circuitry to detect camera motion. If the motion is below a predetermined threshold value, an exposure start signal is activated to begin the integration cycle. If however, the motion is above the predetermined threshold value, then a timer is activated and the integration cycle does not occur until a second exposure start signal is generated upon expiration of the time delay. This technique requires extra control and motion detection circuitry and memory. While this method is useful in preventing motion-induced blur in still camera applications, it may not be practical in devices using miniature camera modules, where space and cost are a major concern.

Another technique for reducing motion induced blur generally concentrates on compensating for the motion by using moveable components and motion sensors to dampen the motion vibration. U.S. Pat. No. 5,659,807, which issued to Nakamura et al on Aug. 19, 1997, discloses a vibration compensation system comprised of a motion detection circuit and a vibration compensation lens. The lens can be moved in relation to the optical axis to negate the effects of the vibration or motion detected. This technique requires complex motion detection circuitry and movable lenses, making it impractical for imaging applications in which cost and size are a major consideration.

U.S. Pat. No. 5,754,670, which issued to Shin et al on May 19, 1998, describes a novel technique for imaging devices, which are moving on a conveyor belt. In a first embodiment, an authentication pattern is positioned near the barcode reader at a predetermined distance. The image reader detects the authentication pattern first, setting off a timer that delays the start of the image capture. This delay synchronizes the image reader with the bar code label such that the barcode will pass directly through the field of view of the image reader at the time of image capture. While this technique is useful for applications in which the image reader is stationery, such as inspection or sorting systems, it is not useful for applications in which the device is a portable image reader operated by a human operator. The delay is useful only in synchronizing the image capture and does not reduce motion induced image blur. Further this technique requires extra symbology, which must be precisely positioned in relation to the target indicia, in order to obtain a successful image capture.

In light of the above described prior art, there is a need for an inexpensive method to reduce motion-induced blur in portable optical readers. Further, there is a need for a method to reduce motion-induced blur that does not significantly increase the circuitry and impact the size of the device. There is also a need for a method to reduce motion induced blur, which is transparent to the human operator of the portable optical device.

### SUMMARY OF THE INVENTION

The present invention is directed to a portable image reader comprising a manual trigger for creating an activation signal to initiate the image acquisition sequence, a delay device electrically coupled to the trigger for delaying said activation signal for a delay time sufficient to minimize the effect of image blur on the image acquisition and acquisition circuitry electrically coupled to the output of the delay device for receiving an activation signal and initiating an image acquisition sequence.

In accordance with a specific aspect of this invention, the delay device may be a programmed delay or a delay device such as a multivibrator to produce a fixed delay in the range of 50 ms to 250 ms.

In accordance with another specific aspect of the invention, the delay device may comprise an accelerometer for measuring the velocity of the motion of the portable image reader and a comparator for determining when the reader has decelerated below a predetermined threshold.

The present invention is further directed to a method of reducing the blurring effects of motion in a portable image reader by triggering an activation signal for the reader, delaying the activation signal for a predetermined time, and then applying the delayed activation signal to the image reader to iniate an image acquisition sequence. Since the jitter amplitude created by the inherent motion of the operator's hand on the portable reader is greatest immediately after the operator triggers the activation signal, maximum jitter is avoided by initiating the acquisition sequence only after the time delay.

In accordance with another aspect of this invention, the method of reducing the blurring effects of motion in a portable image reader may comprise triggering an activation signal for the image reader, delaying the activation signal for the image reader until motion imparted to the image reader has substantially decelerated below a threshold value, and applying the delayed activation signal to the portable imager reader for initiating an image acquisition sequence.

In accordance with a specific aspect of this invention, the duration of the time delay may be in the range of 50 ms to 250 ms.

### BRIEF DESCRIPTION OF THE DRAWINGS

These and other features of the invention will become more apparent from the following description in which reference is made to the appended drawings wherein:

FIG. 1 is a flow chart representation of one embodiment of the present invention;

FIG. 2 is a partial schematic block diagram showing the basic elements of an image reader;

FIG. 3 is a partial schematic block diagram showing an image reader in accordance with the present invention;

FIG. 4 is a block diagram showing a monostable multivibrator device for an embodiment of the present invention;

FIG. 5 is a timing diagram of the operation of the monostable multivibrator device;

FIG. 6 is a partial schematic block diagram of a further embodiment of the present invention; and

FIG. 7 is a flow chart representation of the further embodiment of the present invention.

### DETAILED DESCRIPTION

The present invention provides a method and apparatus for substantially reducing motion-induced blur in portable optical readers. For purposes of explanation, specific embodiments are set forth to provide a thorough understanding of the present invention. However, it will be understood by one skilled in the art, from reading this disclosure, that the invention may be practiced without these specific details. Furthermore, although the present invention is described through the use of CMOS image sensors, most, if not all, aspects of the invention apply to optical sensors in general including CMOS, CCD and laser scanners. Moreover, well-known elements, devices, process steps and the like are not set forth in detail in order to avoid obscuring the scope of the invention described.

In portable devices such as symbology readers and image capture devices, a trigger or switch of some kind is used to activate the electronic shutter and begin the integration (exposure) during image acquisition. A significant problem with these portable readers is the motion induced blur that can occur due to the reactive hand motion of a human operator, sometimes referred to as jitter. When the trigger or switch on the portable reader is pulled or released, the motion imparted can be excessive. If an exposure occurs at this time of excessive motion, then blurring of the image will most likely be very high. It is higher still if the object being imaged is also in motion such as in the case of a package inspection system. These systems require that an image be taken of a package moving along a conveyor belt. The present invention solves the problem of excessive motion induced blur.

When a short delay is introduced after the triggering event has been detected, the kinetic energy introduced by the operator will have mostly dissipated and the motion of the reader will be decreased. The time following this short delay interval is the point at which the reader would be capable of acquiring an image with little motion induced blur.

Experimental use of the invention has found that a limited delay ranging from 50 to 250 ms is generally the time required for reducing motion blur, while still remaining undetectable to the human operator, however in the preferred embodiment the optimal delay time is in the order of 100 ms to 150 ms. The wide range of delay times is necessary because the amplitude of muscle reaction (jitter) that causes the motion induced blurring varies from person to person and may also vary depending on the type of reader used. The 100 ms to 150 ms range is a good compromise and can be tuned during the design of the portable image reader.

The delay can be introduced in a number of ways, in general by means of a software algorithm that simply has a sequence of wait states after the triggering event, or it could be hard-wired using simple delay circuitry. The delay would only occur once a trigger operation has taken place. Any delay circuitry incorporated into the module, such as a 555 timer or microcontroller for example, would take up only a minimal amount of space. Similarly, a simple software algorithm could be used requiring little extra memory. Alternately, the delay may be introduced by an accelerometer that is incorporated into the reader. After being triggered, the accelerometer measures the reader's velocity, the measurement can be used to determine when the reader has decelerated to a point at which is closest to being substantially stationary with respect to the target, this being the optimum time for an image capture to occur.

The details of the present invention will be described in detail below with reference to the accompanying figures and drawings.

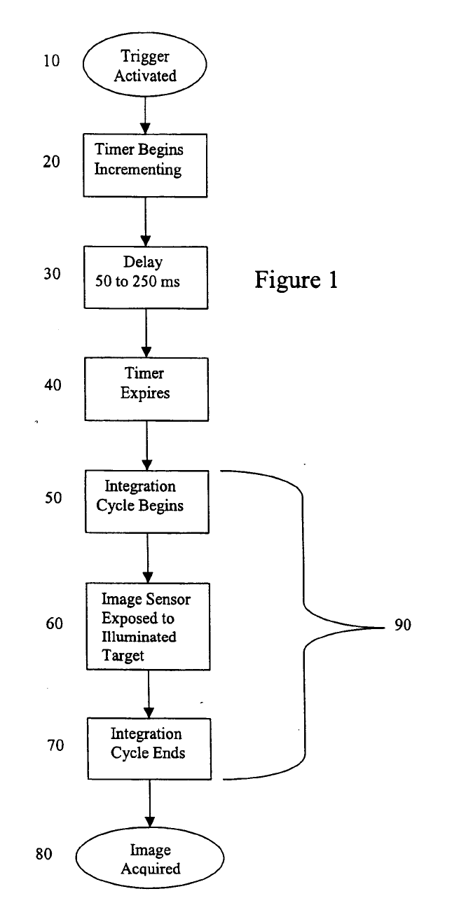

FIG. 1 shows a flow chart representation of the image capture process including the time delay of the present invention. A predetermined fixed delay is incorporated into the imaging device, perhaps by an incrementing timer algorithm. Those skilled in the art will understand that there are numerous ways to incorporate a software algorithm into the device and therefore the method described in this embodiment does not limit the scope of the invention.

When a human operator activates the trigger 10 of the image reader, a time delay algorithm such as an incrementing counter 20 is activated. Those skilled in the art will understand that many different types of time delay algorithms may be used without departing from the scope of the present invention. A time delay range 30 of approximately 50 ms to 250 ms is required in order to acquire an satisfactory image on the reader with reduced motion induced blur. The integration cycle begins 50 upon the expiry of the time delay 40.

The integration cycle 90 is also a fixed duration, which begins with a reset signal sent to the photosensitive array. It is important that the reader become as stationary as possible relative to the target during the integration cycle 90, since the photosensitive array is exposed to the illuminated target 60 for a period of time and at the end of the integration cycle 70, an image of the target is acquired 80 by the reader. The image is then processed or decoded, depending on the specific application of the image reader.

There are many CPU's commercially available that contain counters, which may be software activated as needed. A time delay can be programmed in using a simple algorithm to activate the embedded counter.

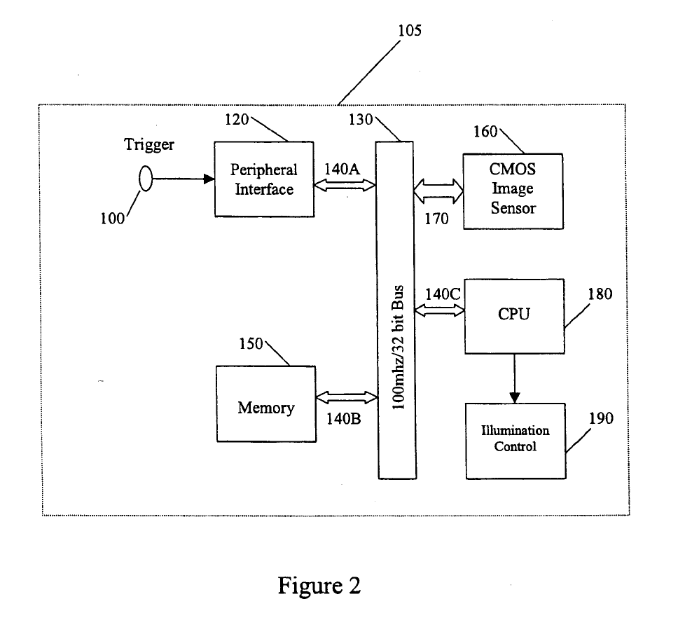

FIG. 2 shows a schematic representation of a CMOS image reader 105 using a dual bus master architecture. The CMOS image reader 105 comprises a trigger mechanism 100 electrically connected to a peripheral interface 120. A 32-bit bus 130 connects the peripheral interface 120 via a bus interface 140A to other devices in the image reader 105 including a memory 150 and a system central processing unit (CPU) 180. The CPU 180 controls an illumination control circuit 190 and an image sensor 160, via the bus interface 140C and an I²C connection 170, and communicates with it's own 32-bit bus 130 via bus interface 140C. The memory 140 communicates with the 32-bit bus 130 via bus interface 140B. In this particular embodiment, a time delay algorithm, which may be found in memory 150, is activated in the CPU 180 in order to delay the start of the of the integration cycle.

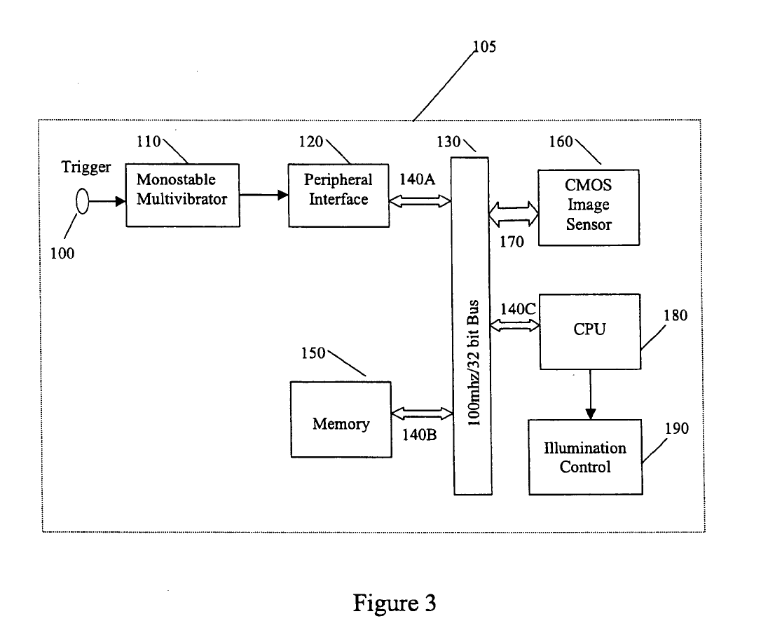

In another embodiment of the present invention, a monostable multivibrator, such as a 555 timer 110 configured to operate as a one shot device, is physically connected between the trigger device 100 and the peripheral interface 120, as illustrated in FIG. 3, such that the input of the timer 110 is electrically connected to the trigger mechanism 100 and the output is connected to a port on the peripheral interface 120. With this approach, the system CPU 180 is relieved from the task of performing the time delay. Those skilled in the art will understand that other types of time delay circuitry may be used without departing from the scope of the present invention.

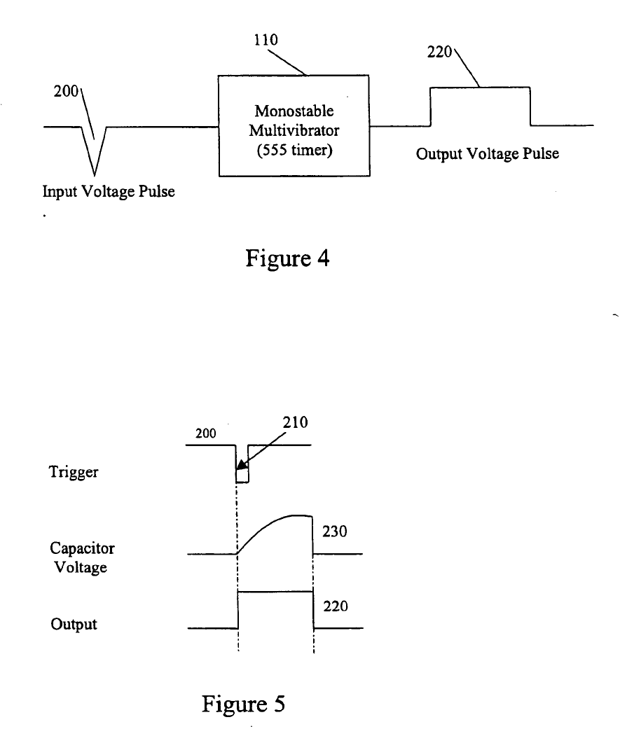

One-shot timers are an inexpensive means of developing non-critical timing delays. With reference to FIG. 4, when operated in the one-shot mode, a 555 timer 110 has a single stable OFF state. When an input trigger pulse 200 is received, the timer 110 switches to a temporary ON state after a period of time determined by an RC circuit (not shown). One disadvantage to using a one-shot timer is that the input pulse duration must be shorter than the required output. The inclusion of an RC circuit overcomes this problem by introducing capacitive coupling at the input. The RC circuit is triggered by the input trigger pulse 200, allowing the capacitor to be charged by the supply voltage through a resistor. The amount of time it takes for the supply voltage to charge the capacitor is dependent on the rating of the capacitor and resistor used, which will determine the delay time. When the time period created by the RC circuit expires, the timer 110 returns to its stable Off state. The timer 110 produces a single pulse at the output 220, which has a wider time duration in comparison to the input pulse 200.

FIG. 5 is a timing diagram representation of the present invention. The timer 110 of the present embodiment is activated by the falling edge 210 of the negative input trigger pulse 200. When the trigger pulse 200 is received, the output 220 changes states while the capacitor voltage 230 increases as the capacitor charges. The capacitor voltage 230 keeps the output 220 high for a fixed duration of time. When the capacitor voltage 230 stops increasing, the output 220 goes low, returning the timer 110 to its stable state.

The following basic formula is used to determine the time duration of the output pulse:
T=1.1RC
Therefore, if the resistance is 1 mega-ohms and the capacitance is 0.1 microfarads, then the time delay is 110 ms.

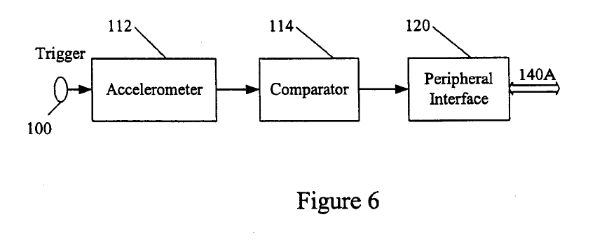

In a further embodiment of the present invention as illustrated in FIG. 6, the monostable multivibrator 110 in the reader 105 illustrated in FIG. 3 may be replaced by an accelerometer 112, which, when triggered by trigger 100, provides an accurate measurement of the velocity of the reader 105 during the image capture cycle. The accelerometer 112 is followed by a comparator 114 for determining when the portable reader 105 has decelerated below a predetermined threshold velocity. The accelerometer 112 is used to precisely determine the point at which the reader 105 velocity is at its lowest, i.e. when the reader 105 is most stationary. The comparator 114 output is coupled to a port on the peripheral interface 120 and is used to synchronize the image capture event with the point at which the reader 105 is moving the least, typically resulting in a delay of a short interval of approximately 100 ms after the initial trigger event by trigger 100. At this point, the integration cycle begins and an image of the target is acquired.

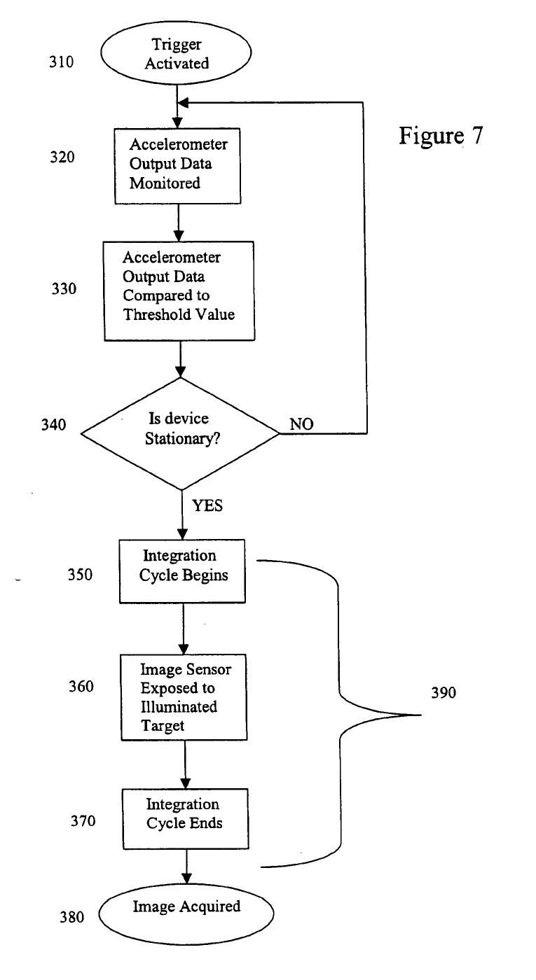

The accelerometer may be a monolithic IC mounted on the main circuit board of the portable image reader 105. Referring to the flowchart of FIG. 7, the accelerometer 112 detects the velocity of the reader 105 after the trigger event 310. The motion data output from the accelerometer 112 is received and monitored 320 by a comparator 114. A threshold value representative of a decelerated and substantially stationary reader 105, is compared to the monitored data 330. This value corresponds to the optimal time for obtaining an image with little motion induced blur. If the threshold is reached within a predetermined time frame, indicating that the reader 105 is substantially stationary, the integration cycle 350 begins. If the threshhold is not reached, the accelerometer cycle 320, 330 repeats itself. The integration cycle 390 is a fixed duration, which begins with a reset signal sent to the photosensitive array. It is important that the reader 105 become as stationary as possible during the integration cycle 390, since the photosensitive array is exposed to the illuminated target 360 for a period of time and at the end of the integration cycle 370 an image of the target is acquired 380 by the reader 105. The image is then processed or decoded, depending on the specific application of the image reader 105.

The prime advantage of the present invention is that it provides a mechanism for reducing motion-induced blur in portable image readers. However, in addition, with the incorporation of a time delay after the portable reader is triggered, the integration time may be extended. With a longer integration time, less illumination is required and image quality is improved. Further, a larger aperture in the lens can be used to receive more light, improving the depth of field. Also, the mechanism for reducing motion induced blur is transparent to the human operator of the portable reader.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

1. A portable image reader comprising;
a trigger for providing an activation signal to initiate an image acquisition sequence;
a delay device coupled to said trigger for delaying said activation signal for a predetermined delay time to reduce the effect of image blur on image acquisition by the image reader; and
acquisition circuitry coupled to said delay device for receiving said delayed activation signal for initiating said image acquisition sequence.

2. A portable image reader as claimed in claim 1 wherein the delay device comprises a monostable multivibrator.

3. A portable image reader as claimed in claim 1 wherein the delay device comprises a central processing unit (CPU).

4. A portable image reader as claimed in claim 1 wherein the delay device provides a delay in the order of 50 ms to 250 ms.

5. A portable image reader as claimed in claim 1 wherein the delay device provides a delay between 100 ms and 150 ms.

6. A portable image reader as claimed in claim 1 wherein the delay device comprises an accelerometer for measuring velocity of the image reader and a comparator for determining when the reader has decelerated below a predetermined threshold.

7. A portable image reader comprising:
a trigger for providing an activation signal to initiate an image acquisition sequence;
a delay device coupled to said trigger for delaying said activation signal until motion imparted on said portable image reader has substantially decelerated to reduce the effect of image blur on image acquisition by the image reader; and
acquisition circuitry coupled to said delay device for receiving said delayed activation signal for initiating said image acquisition sequence.

8. A portable image reader as claimed in claim 7 wherein the delay device comprises an accelerometer for measuring velocity of the image reader and a comparator for determining when the reader has decelerated below a predetermined threshold.

9. A method of reducing the blurring effects of motion in a portable image reader comprising the steps of:
a) triggering an activation signal for the image reader;
b) delaying the activation signal for a predetermined period of time; and
c) applying the delayed activation signal to the portable imager reader for initiating an image acquisition sequence.

10. A method of reducing the blurring effects of motion in a portable image reader wherein the predetermined delay time is in the order of 50 ms to 250 ms.

11. A method of reducing the blurring effects of motion in a portable image reader wherein the predetermined delay time is between 100 ms and 150 ms.

12. A method of reducing the blurring effects of motion in a portable image reader comprising the steps of.
a) triggering an activation signal for the image reader;
b) delaying the activation signal for the image reader until motion imparted to the portable image reader has substantially decelerated below a predetermined threshold; and
c) applying the delayed activation signal to the portable imager reader for initiating an image acquisition sequence.
